(19) United States
(12) Patent Application Publication
(10) Pub. No.: US 2009/0033311 A1
(43) Pub. Date: Feb. 5, 2009

(54) Current Source with Power Supply Voltage Variation Compensation

(75) Inventor: Michael A. Sperling, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/833,593

(22) Filed: Aug. 3, 2007

(51) Int. Cl. G05F 3/20

(52) U.S. Cl. 323/316

(57) ABSTRACT

A multipath current source has separate reference current, control current and output current paths. Voltages in the reference current and control current paths are monitored. Any differences between those two voltages are fed to the gates of current control devices in the reference, control and output current paths to maintain the currents in all paths substantially constant with changes in supply voltage.

### FIELD OF THE INVENTION

The present invention relates to power sources, more particularly to a constant current source with power supply voltage variation compensation.

### BACKGROUND OF THE INVENTION

As technology advances, circuitry has to adapt to the higher tolerances that are present in modern lithographic processes. By controlling the transconductance of transistors, many analog circuits including amplifiers, current mode logic circuitry and I/Os are able to keep their parameters constant. Past solutions to this problem all suffer from one common ailment: sensitivity to power supply voltage. U.S. Pat. Nos. 4,890,052 and 6,727,748 both attempt to lower power supply sensitivity by adding cascaded transistors. Both of these patents disclose imperfect solution where the controlled current still changes with supply voltage. U.S. Pat. Nos. 6,559,720 and 5,777,518 also discloses circuits that attempt to control the power supply sensitivity. However, the circuit of U.S. Pat. No. 6,559,720 requires external input voltages while the one in U.S. Pat. No. 5,777,518 requires an ideal current source, as well as an external voltage reference to function and is still sensitive to power supply variations in that it does not provide for control the drains of all transistors.

One prior art form of constant current source is shown in FIG. 1. This current source contains two separate paths between the voltage VDD and ground. The first or reference current path provides a reference current Iref while the second or controlled current path provides a mirrored current path Imir. NFET transistors 104 and 108 are arranged in parallel such that their gate voltage is the same. NFET 108 is sized N times larger than 104 where N is a positive integer greater than 1. The source of NFET 104 is connected to ground while the source of NFET 108 is connected to Resistor RL. The other end of resistor RL is connected to ground such that the difference between the gate to source voltages of NFETs 104 and 108 appears across resistor RL. Thus the reference current Iref thru path Iref 106 will be equal to that difference in voltage divided by the resistance of RL. The gate and drain of PFET 110 are shorted together such that PFET 110 effectively functions as a diode with current Iref going from the drain voltage V2 to the source voltage VDD. PFET 102 is connected in parallel to PFET 110 such that both transistors share the same gate and source voltages, V2 and VDD respectively. Thus, PFET 102 mirrors the current of PFET 110 down current path Imir 100. NFET 104 is arranged with its drain voltage V1 shorted to its gate also effectively functioning as a diode. This helps maintain the same current between Iref and Imir.

When the power supply voltage VDD changes, voltage V2 will change with it since the drain of PFET 110 is shorted to its gate and that gate voltage will track changes in source voltage VDD. However, voltage V1 will not change since the drain of NFET 104 is shorted to its gate and that gate voltage will stay constant relative to source voltage ground. As a result, the drain voltage of PFET 102 will not change while the drain voltage of PFET 110 will. This will result in currents Iref and Imir mistracking and causing a change in current Iref in response to VDD changes according to the following equation:

I=½*μ*C_{OX}*(W/L)*(V_{GS}−V_{TH})²*(1+λ*V_{DS})
I=Drain to source current of PFET 110
μ=Mobility of charge carriers
C_{OX}=Capacitance per area of the gate
(W/L)=Device width to length ratio
V_{GS}=Gate to source voltage
V_{DS}=Drain to source voltage
V_{TH}=Threshold voltage
λ=Channel length modulation coefficient.
   So, the output current is a function of the Drain to source voltage and therefore a function of the power supply voltage VDD.

Therefore, it is an object of the invention to provide a improved current source.

It is a further object of the invention to provide a constant current source with improved response to changes in supply voltage.

Further objects of the invention include a current source which have improved response to changes in conditions which does not rely on external control voltages.

### BRIEF DESCRIPTION OF THE INVENTION

In accordance with the present invention, an improved multipath current source is provided. In this current source, the gates of current controlled devices in both the reference and controlled current paths are connected to the output of a differential amplifying stage with one input coupled to the drain of the output control device in the reference current path and the other input connected to the drain of the control device in the controlled current path. This differential amplifier senses any difference between the two voltages V1 and V2 at the drains of both devices. This reduces the effect of a variation in the voltage supply voltage VDD on current in both paths. In the preferred embodiment, a third output path is fed current from the source VDD through an additional device that receives Vgs as its gate excitation. With this arrangement, the current control devices in both the reference arid controlled current paths can have the same current carrying capacity further reducing the affect of variations in VDD on current through the third output path.

### BRIEF DESCRIPTION OF THE DRAWINGS

These and other features and aspects of applicants' invention can best be better understood by reference to the accompanying figures of which:

FIG. 1 is a schematic diagram of a prior art constant current source.

FIG. 2 is a schematic diagram of a constant current source in accordance with the present invention; and

FIG. 3 is a differential amplifier used in connection with the constant current source of FIG. 2.

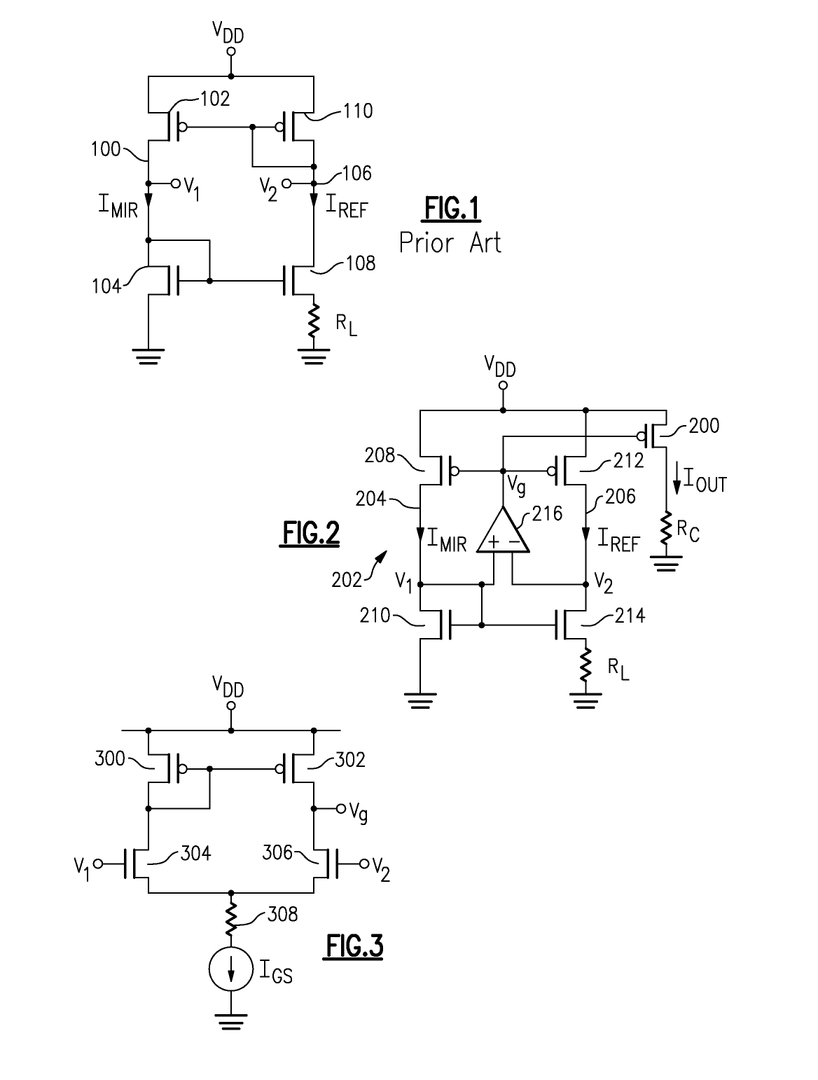

### DETAILED DESCRIPTION OF THE INVENTION

Referring now to FIG. 2, PFET 200 is connected in series with circuitry Rc between VDD and ground to control the current Iout through the circuitry Rc. A voltage Vg from a fixed current source 202 is used to control the current Iout. This current source 202 contains separate paths 204 and 206 between the voltage source VDD and ground. The first or reference current path 206 provides a reference current Iref while the second or controlled current path 204 provides a mirrored current Imir. In the reference current path 206, a current regulation PFET device 212 is connected in series with NFET device 214 and resistor RL between VDD and ground. In the mirrored current path current regulation PFET device 208 is connected in series with NFET device 210 between VDD and ground. The gates of PFET devices 208 and 212 are tied together to receive the same gate voltage Vg and thus closely match the currents Iref and Imir. The gates of NFET devices 210 and 214 are also tied together in order to set the current according to the relative size of NFET 214 to NFET 210 and the resistor RL. However, as pointed out above, equality of V1 and V2 is not necessarily secured by this arrangement causing the currents Iref and Imir to be different. To correct this voltage difference, a differential amplifier 216 is used to detect differences between V1 and V2 and use it to vary Vg with changes in VDD. Vg is also used as the gate voltage of PFET 200 so that the output current Iout will stay constant with changes hi the voltage VDD.

In the differential amplifier shown in FIG. 3, two PFET devices 300 and 302 have their sources connected to positive voltage supply terminal VDD and their gates coupled together. The gate of one of the PFETs is connected to its drain so that PFET 300 functions as a diode. The drains of both of the PFETs 300 are connected to the drains of NFETs 304 and 306. The sources of the NFETs are connected together and through a large impedance 308 functioning with VDD as a current source Iss. The gates of the NFETs 304 and 306 are connected across the drains of devices 208 and 212 of FIG. 2 to monitor differences between V1 and V2. The output of the differential amplifier is connected to the gates of the PFETs 200, 208 and 210 to provide the gate voltage Vg for those devices thereby maintaining Iref, Icont and Iout substantially constant.

One embodiment of the present invention has been described. Obviously, a number of changes can be made to this embodiment without departing from the spirit and scope of the invention. For instance, the functions of the PFETs and NFETs can be reversed and the circuit used with a negative voltage source to provide a constant current source. Further, a different differential amplifier and device other than PFETs and NFETs could be used. Therefore it should be understood that the present invention is not limited to the disclosed embodiment but should cover those changes that fall within the spirit and scope of the appended claims.

What is claimed is:

1. A multipath constant current source with a reference current path and a controlled current path connected to a voltage source with the current in the control current path responsive to current in the reference current path comprising:
a current control device in each of the reference and controlled current paths with their gates coupled together;
load devices in each of the paths coupled with their gates connected together; and
a differential amplifier with one input connected between the control current device and the load device in the reference current path and another input connected between the control current device and the load device in the controlled current path and its output connected to the gates of the two current control devices so that the gate voltage on the two current control devices reflects any difference between voltages at its inputs detected by the differential amplifier to reduce any differences between currents in the two paths.

2. The multipath constant current source of claim 1 with a third path connected to the voltage source providing a constant current to a load said third path containing a third current control device connected in the third path to control the current to the load which current control device has its gate connected to the gates of the control current devices in the current control path and the reference current path.

3. The multipath constant current source of claim 2, wherein all the current control devices all operate out of saturation so that the current in the paths are responsive to the changes in voltage on the gates of the devices.

4. The multipath constant current source of claim 3, wherein the current control devices are PFET devices.

5. The multipath constant current, source of claim 4, wherein the load devices are NFET devices.

6. The multipath constant current source of claim 5, wherein the source is a positive voltage source.

7. The multipath constant current source of claim 6, wherein the gate to source path of the load device in the reference current path are shorted together and to an input terminal of the differential amplifier.

8. The multipath constant current source of claim 7, wherein the inputs to the differential amplifier are connected between the drains of the PFETs and the source of the NFETs in both paths.

9. The multipath constant current source of claim 8, wherein the differential amplifier is connected to a constant current source fed by the voltage source.

10. The multipath constant current source of claim 9, wherein the differential amplifier contains two paths with a PFET and an NFET in both paths.

11. A method of compensating for voltage source variation in a multipath constant current source with a reference current path and a controlled current path connected to a voltage source with the current in the control current path responsive to current in the reference current path the steps comprising:
having a current control device in each of the paths with their gates coupled together;
having a load device in each of the paths coupled to the voltage source in series with the current control device in the same path; and
a differential amplifier with one input connected between the control current device and the load device in the reference current path and another input connected between the control current device and the load device in the controlled current path and its output connected to the gates of the two current control device so that the gate voltage on the two current control devices reflects any differences between voltages at its inputs detected by the differential amplifier to reduce any differences between currents in the two paths.

12. The method of claim 11 including the step of providing a third path connected to the voltage source to provide a constant currant to a bad said third path containing a load current control device connected in the third path to control the current to the load which current control has its gate connected to the gates of the control current devices in the current control path and the reference current path.

13. The method of claim 12 including the step of operating all the current control devices out of saturation so that the current in the paths are responsive to the changes in voltage on the gates of all the devices.

14. The method of claim 13 including the step of using PFET devices as the current control devices.

15. The method of claim 14 including the step of having the load devices that are NFET devices.

16. The method of claim 15 including using a positive voltage source as the voltage source.

17. The method of claim 16 including the steps of shorting together the gate to source path of the load device in the reference current path and coupling that path to an input terminal of the differential amplifier.

18. The method of claim 17 including the step of connecting an input to the differential amplifier between the drains of the PFETs and the source of the NFETs m the current referenced controlled sequence paths.

19. The method of claim 18 including the step of connecting the differential amplifier to a constant current source fed by the voltage source.

20. The method of claim 19 including the step of having the differential amplifier contain two paths with a PFET and an NFET in both paths.
